(19) United States
(12) Patent Application Publication
(10) Pub. No.: US 2024/0155482 A1
(43) Pub. Date: May 9, 2024

(54) Bluetooth audio playback apparatus and Bluetooth communication method thereof having audio source scanning mechanism

(71) Applicant: REALTEK SEMICONDUCTOR CORPORATION, HSINCHU (TW)

(72) Inventors: WEI-FENG MAO, Suzhou (CN); JI-DONG CHEN, Suzhou (CN); SI-QI LU, Suzhou (CN); QI XU, Suzhou (CN); WEI-DONG LI, Suzhou (CN); ZHEN-NAN ZHANG, Suzhou (CN)

(21) Appl. No.: 18/234,411

(22) Filed: Aug. 16, 2023

(30) Foreign Application Priority Data
Nov. 7, 2022 (CN) 202211386226.0

(51) Int. Cl. H04W 48/20; H04R 3/00; H04W 76/10

(52) U.S. Cl. CPC H04W 48/20; H04R 3/00; H04W 76/10; H04R 2420/07

(57) ABSTRACT

The present disclosure discloses a Bluetooth communication method having audio source scanning mechanism and used in a Bluetooth audio play playback apparatus that includes steps outlined below. A one-to-one connection is established with a Bluetooth communication assistant apparatus. An audio source scanning is performed to generate audio source information according to a scanned Bluetooth audio source apparatus. The audio source information is transmitted to the Bluetooth communication assistant apparatus. A selection command from the Bluetooth communication assistant apparatus is received to select the scanned Bluetooth audio source apparatus as a selected Bluetooth audio source apparatus. Audio data from the selected Bluetooth audio source apparatus is received and playback.

### BACKGROUND OF THE INVENTION

### 1. Field of the Invention

The present disclosure relates to a Bluetooth audio playback apparatus and a Bluetooth communication method thereof having audio source scanning mechanism

### 2. Description of Related Art

Wireless communication technology does not require connections of physical wires to perform communication and thus becomes a mainstream communication technology. Among various kinds of wireless communication technologies, Bluetooth technology has developed for more than thirty years and is important in different fields of telecom, computer, network and consumer electronics products.

However, in some applications, an audio playback apparatus equipped with Bluetooth technology requires the assistance of a Bluetooth communication assistant apparatus to perform connection with a Bluetooth audio source apparatus. When the software or hardware ability of the Bluetooth communication assistant apparatus is not enough, the communication between the audio playback apparatus and the Bluetooth audio source apparatus is affected.

### SUMMARY OF THE INVENTION

In consideration of the problem of the prior art, an object of the present disclosure is to provide a Bluetooth audio playback apparatus and a Bluetooth communication method thereof having audio source scanning mechanism.

The present invention discloses a Bluetooth audio playback apparatus having audio source scanning mechanism that includes a communication circuit and a processing circuit. The processing circuit is configured to perform steps outlined below. A one-to-one connection is established with a Bluetooth communication assistant apparatus through the communication circuit. An audio source scanning is performed through the communication circuit and audio source information is generated according to a Bluetooth audio source apparatus that is found during the audio source scanning. The audio source information is transmitted to the Bluetooth communication assistant apparatus through the communication circuit. A selection command is received from the Bluetooth communication assistant apparatus through the communication circuit to select the Bluetooth audio source apparatus as a selected Bluetooth audio source apparatus. Audio data from the selected Bluetooth audio source apparatus is received through the communication circuit and the audio data is playbacked.

The present invention also discloses a Bluetooth communication method having audio source scanning mechanism used in a Bluetooth audio playback apparatus that includes steps outlined below. A one-to-one connection is established with a Bluetooth communication assistant apparatus. An audio source scanning is performed and audio source information is generated according to a Bluetooth audio source apparatus that is found during the audio source scanning. The audio source information is transmitted to the Bluetooth communication assistant apparatus. A selection command is received from the Bluetooth communication assistant apparatus to select the Bluetooth audio source apparatus as a selected Bluetooth audio source apparatus. Audio data from the selected Bluetooth audio source apparatus is received and the audio data is playbacked.

These and other objectives of the present disclosure will no doubt become obvious to those of ordinary skill in the art after reading the following detailed description of the preferred embodiments that are illustrated in the various figures and drawings.

### BRIEF DESCRIPTION OF THE DRAWINGS

FIG. 1 illustrates a block diagram of a Bluetooth communication system according to an embodiment of the present invention.

FIG. 2 illustrates a flow chart of a Bluetooth communication method according to an embodiment of the present invention.

### DETAILED DESCRIPTION OF THE PREFERRED EMBODIMENTS

An aspect of the present invention is to provide a Bluetooth audio playback apparatus and a Bluetooth communication method thereof having audio source scanning mechanism to establish one-to-one connection with a Bluetooth communication assistant apparatus that may be equipped with various kinds of software and hardware formats to perform audio source scanning by itself and transmit the audio source information to the Bluetooth communication assistant apparatus, so as to perform selection based on a selection command from the Bluetooth communication assistant apparatus to receive and playback audio data from a selected Bluetooth audio source apparatus. The Bluetooth audio playback apparatus can perform communication with the Bluetooth audio source apparatus without being limited by the ability of the Bluetooth communication assistant apparatus.

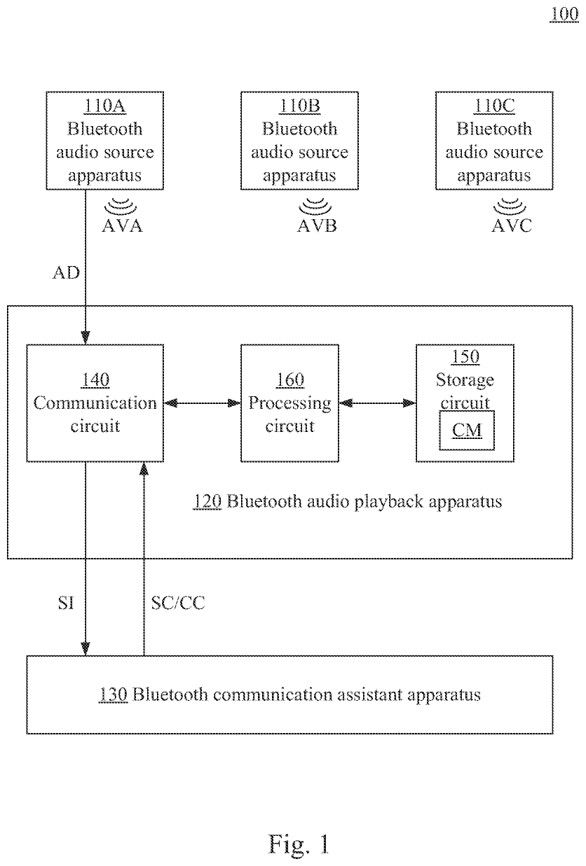

Reference is now made to FIG. 1. FIG. 1 illustrates a block diagram of a Bluetooth communication system 100 according to an embodiment of the present invention. The Bluetooth communication system 100 includes a plurality of Bluetooth audio source apparatuses 110A-410C, a Bluetooth audio playback apparatus 120 and a Bluetooth communication assistant apparatus 130.

In an embodiment, the Bluetooth audio source apparatuses 110A-410C, the Bluetooth audio playback apparatus 120 and the Bluetooth communication assistant apparatus 130 perform communication by using Public Broadcast Profile (PBP) of the Auracast technology.

Each of the Bluetooth audio source apparatuses 110A-410C can be a Public Broadcast Source (PBS) defined in the PBP specification and can be such as, but not limited to a television, a laptop, a tablet PC, a public broadcast system, a smartphone or other electronic apparatuses configured to provide audio data.

The Bluetooth audio playback apparatus 120 can be a Public Broadcast Sink (PBK) defined in the PBP specification and can be such as, but not limited to a headset, an earphone, a hearing aid, a speaker or other electronic apparatuses configured to receive and playback the audio data.

The Bluetooth communication assistant apparatus 130 can be a Public Broadcast Assistant (PBA) defined in the PBP specification and can be such as, but not limited to a smartphone, a smart watch, a hearing aid remote controller or other electronic apparatuses configured to connect to a Public Broadcast Sink and control the Public Broadcast Sink.

The Bluetooth audio playback apparatus 120 can perform scanning without the aid of other apparatuses to find the Bluetooth audio source apparatuses 110A-410C within the neighboring area and perform communication with one of the Bluetooth audio source apparatuses 110A-410C according to the scanning result.

The configuration of the Bluetooth audio playback apparatus 120 is described in detail in the following paragraphs.

The Bluetooth audio playback apparatus 120 includes a communication circuit 140, a storage circuit 150 and a processing circuit 160.

The communication circuit 140 can be any circuit that is configured to perform communication with the Bluetooth audio source apparatuses 110A-410C and the Bluetooth communication assistant apparatus 130 by using wireless or wired communication technologies.

The storage circuit 150 can be any storage device that stores data, such as but not limited to a random access memory (RAM), a read only memory (ROM) or a hard drive. It is appreciated that in various embodiments, the storage circuit 150 may include only one or more than one storage devices described above to store different types of data. In an embodiment, the storage circuit 150 is configured to store computer executable commands CM.

The processing circuit 160 is electrically coupled to the communication circuit 140 and the storage circuit 150. In an embodiment, the processing circuit 160 is configured to retrieve and execute the computer executable commands CM from the storage circuit 150. The computer executable commands CM includes such as, but not limited to firmware/driver and related commands of the hardware modules of the communication circuit 140 and the storage circuit 150 to access the signals or data of the communication circuit 140 and the storage circuit 150 perform operation thereon to execute the function of the Bluetooth audio playback apparatus 120.

The operation of the Bluetooth audio playback apparatus 120 is described in detail in the following paragraphs.

A one-to-one connection is established with the Bluetooth communication assistant apparatus 130 through the communication circuit 140 by the processing circuit 160. In different embodiments, the one-to-one connection with the Bluetooth communication assistant apparatus 130 is established through the communication circuit 140 by the processing circuit 160 by using Generic Attribute Profile (GATT) protocol, Serial Port Profile (SPP) protocol, Radio frequency communication (RFCOMM) protocol, Logical Link Control and Adaptation Protocol (L2CAP), Basic Rate/Enhanced Data Rate Asynchronous Connection-Oriented Logical Transport (BR/EDR ACL) protocol or Low Energy ACL (LE ACL) protocol.

Subsequently, an audio source scanning is performed through the communication circuit 140 and audio source information SI is generated according to the Bluetooth audio source apparatuses 110A-410C that are found during the audio source scanning by the processing circuit 160.

In an embodiment, a scan command SC is received from the Bluetooth communication assistant apparatus 130 through the communication circuit 140 by the processing circuit 160 and the audio source scanning is performed according to the scan command SC by the processing circuit 160.

More specifically, the Bluetooth communication assistant apparatus 130 may be equipped with such as, but not limited to an application program for controlling the Bluetooth audio playback apparatus 120 and generate the scan command SC under the operation of a user to transmit the scan command SC to the Bluetooth audio playback apparatus 120. The Bluetooth audio playback apparatus 120 further performs audio source scanning according to the scan command SC.

In another embodiment, the processing circuit 160 may actively perform the audio source scanning through the communication circuit 140. More specifically, after the Bluetooth audio playback apparatus 120 is initialized, the processing circuit 160 actively performs the audio source scanning without being triggered by an external device (e.g., the Bluetooth communication assistant apparatus 130) in advance.

The Bluetooth audio source apparatuses 110A-410C are configured to transmit broadcast packets AVA-AVC, such as but not limited to a periodic advertising packet and/or an extended advertising packet that is transmitted every 200 milliseconds. The broadcast packets AVA-AVC are therefore received through the communication circuit 140 by the processing circuit 160 to perform audio source scanning. The broadcast packets AVA-AVC may include such as, but not limited to identification information of the Bluetooth audio source apparatuses 110A-410C. The audio source information SI is further generated by the processing circuit 160 accordingly, in which the audio source information SI include such as, but not limited to the identification information of the Bluetooth audio source apparatuses 110A-410C described above.

The audio source information SI is transmitted to the Bluetooth communication assistant apparatus 130 through the communication circuit 140 by the processing circuit 160.

A selection command CC is received from the Bluetooth communication assistant apparatus 130 through the communication circuit 140 to select one of the Bluetooth audio source apparatuses 110A-110C as a selected Bluetooth audio source apparatus.

More specifically, the Bluetooth communication assistant apparatus 130 may be equipped with such as, but not limited to an application program for controlling the Bluetooth audio playback apparatus 120 to display the related information of the Bluetooth audio source apparatuses 110A-410C on a display device included by the Bluetooth communication assistant apparatus 130 after receiving the audio source information SI so as to generate the selection command CC based on the operation of the user. After receiving the selection command CC, one of the Bluetooth audio source apparatuses 110A-410C, e.g., the Bluetooth audio source apparatus 110A, is selected by the processing circuit 160 as the selected Bluetooth audio source apparatus.

Audio data AD is received from the selected Bluetooth audio source apparatus 110A through the communication circuit 140 by the processing circuit 160 and the audio data AD is playbacked by the processing circuit 160.

In some approaches, the scanning and the selection of the audio sources are all performed by the Bluetooth communication assistant apparatus, in which the Bluetooth audio playback apparatus performs communication with the Bluetooth audio source apparatus passively under the control of the Bluetooth communication assistant apparatus. However, when the ability of the software or hardware of the Bluetooth communication assistant apparatus is not enough, e.g., being unable to support the specification higher than Bluetooth 5.0 version or being only equipped with lower level operation system, the Bluetooth audio playback apparatus can not establish communication with the Bluetooth audio source apparatus.

The Bluetooth audio playback apparatus of the present invention establishes one-to-one connection with a Bluetooth communication assistant apparatus that may be equipped with various kinds of software and hardware formats to perform audio source scanning by itself and transmit the audio source information to the Bluetooth communication assistant apparatus, so as to perform selection based on a selection command from the Bluetooth communication assistant apparatus to receive and playback audio data from a selected Bluetooth audio source apparatus. The Bluetooth audio playback apparatus can perform communication with the Bluetooth audio source apparatus without being limited by the ability of the Bluetooth communication assistant apparatus.

It is appreciated that a selection performed on three Bluetooth audio source apparatuses 110A-110C is used as an example in the embodiment described above. In other embodiments, the number of the Bluetooth audio source apparatus can be any number that is one or more than one.

Further, the function implemented according to the execution of the computer executable commands CM by the processing circuit 160 in the Bluetooth audio playback apparatus 120 is used as an example in the embodiment described above. In other embodiments, the processing circuit 160 may include a plurality of hardware circuits for specific functions such that the function of the Bluetooth audio playback apparatus 120 can be implemented according to the operation of these hardware circuits of the processing circuit 160.

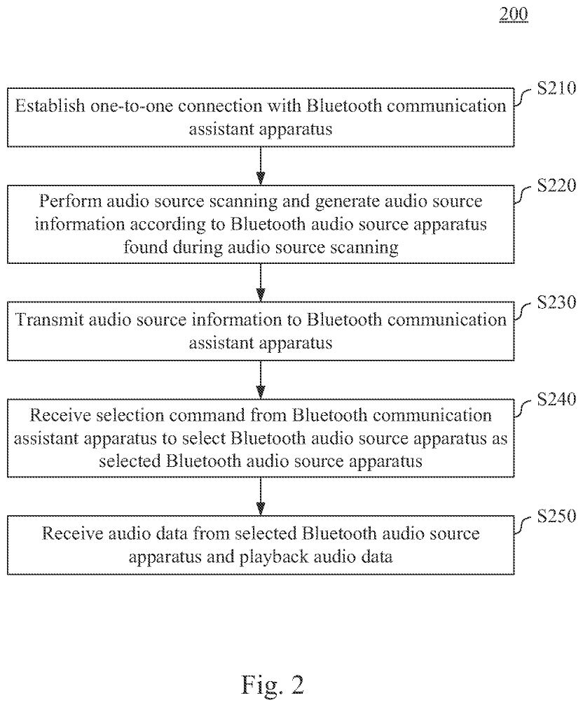

Reference is now made to FIG. 2. FIG. 2 illustrates a flow chart of a Bluetooth communication method 200 according to an embodiment of the present invention.

Besides the apparatus described above, the present invention further discloses the Bluetooth communication method 200 that can be used in such as, but not limited to the Bluetooth audio playback apparatus 120 illustrated in FIG. 1. An embodiment of the Bluetooth communication method 200 is illustrated in FIG. 2 as an example and includes the steps outlined below.

In step S210, the one-to-one connection is established with the Bluetooth communication assistant apparatus 130 through the communication circuit 140 by the processing circuit 160.

In step S220, the audio source scanning is performed through the communication circuit 140 and the audio source information SI is generated according to the Bluetooth audio source apparatuses 110A-410C that are found during the audio source scanning by the processing circuit 160.

In step S230, the audio source information SI is transmitted to the Bluetooth communication assistant apparatus 130 through the communication circuit 140 by the processing circuit 160.

In step S240, the selection command CC is received from the Bluetooth communication assistant apparatus 130 through the communication circuit 140 to select the Bluetooth audio source apparatus 110A as the selected Bluetooth audio source apparatus by the processing circuit 160.

In step S250, the audio data AD from the selected Bluetooth audio source apparatus 110A is received through the communication circuit 140 and the audio data AD is playbacked by the processing circuit 160.

It is appreciated that the embodiments described above are merely an example. In other embodiments, it is appreciated that many modifications and changes may be made by those of ordinary skill in the art without departing, from the spirit of the invention. It is also appreciated that besides the order of the steps that are specifically described, the order of these steps in the flow chart of the method in the present invention can be adjusted according to practical requirements and may be performed simultaneously or partially simultaneously. Further, the term “and/or” in the present specification implies one or more than one combinations of the related items.

In summary, the a Bluetooth audio playback apparatus and a Bluetooth communication method thereof having audio source scanning mechanism establish one-to-one connection with a Bluetooth communication assistant apparatus that may be equipped with various kinds of software and hardware formats to perform audio source scanning by itself and transmit the audio source information to the Bluetooth communication assistant apparatus, so as to perform selection based on a selection command from the Bluetooth communication assistant apparatus to receive and playback audio data from a selected Bluetooth audio source apparatus. The Bluetooth audio playback apparatus can perform communication with the Bluetooth audio source apparatus without being limited by the ability of the Bluetooth communication assistant apparatus.

The aforementioned descriptions represent merely the preferred embodiments of the present disclosure, without any intention to limit the scope of the present disclosure thereto. Various equivalent changes, alterations, or modifications based on the claims of present disclosure are all consequently viewed as being embraced by the scope of the present disclosure.

What is claimed is:

1. A Bluetooth audio playback apparatus having audio source scanning mechanism, comprising:
a communication circuit; and
a processing circuit configured to:
establish a one-to-one connection with a Bluetooth communication assistant apparatus through the communication circuit;
perform an audio source scanning through the communication circuit and generate audio source information according to a Bluetooth audio source apparatus that is found during the audio source scanning;
transmit the audio source information to the Bluetooth communication assistant apparatus through the communication circuit;
receive a selection command from the Bluetooth communication assistant apparatus through the communication circuit to select the Bluetooth audio source apparatus as a selected Bluetooth audio source apparatus; and
receive audio data from the selected Bluetooth audio source apparatus through the communication circuit and playback the audio data.

2. The Bluetooth audio playback apparatus of claim 1, wherein the processing circuit is further configured to:
find Bluetooth audio source apparatuses having a number of more than one during the audio source scanning through the communication circuit, wherein the audio source information comprises information of the all the Bluetooth audio source apparatuses that are found during the audio source scanning, and the selection command selects one of the Bluetooth audio source apparatuses that are found during the audio source scanning as the selected Bluetooth audio source apparatus.

3. The Bluetooth audio playback apparatus of claim 1, wherein the processing circuit is further configured to:
receive a scan command from the Bluetooth communication assistant apparatus through the communication circuit and perform the audio source scanning according to the scan command.

4. The Bluetooth audio playback apparatus of claim 1, wherein the processing circuit is further configured to:
actively perform the audio source scanning through the communication circuit.

5. The Bluetooth audio playback apparatus of claim 1, wherein the processing circuit is further configured to:
establish the one-to-one connection with the Bluetooth communication assistant apparatus through the communication circuit by using Generic Attribute Profile (GATT) protocol, Serial Port Profile (SPP) protocol, Radio frequency communication (RFCOMM) protocol, Logical Link Control and Adaptation Protocol (L2CAP), Basic Rate/Enhanced Data Rate Asynchronous Connection-Oriented Logical Transport (BR/EDR ACL) protocol or Low Energy ACL (LE ACL) protocol.

6. The Bluetooth audio playback apparatus of claim 1, wherein the processing circuit is further configured to:
receive at least one of a periodic advertising packet and an extended advertising packet transmitted by the Bluetooth audio source apparatus through the communication circuit to perform the audio source scanning.

7. A Bluetooth communication method having audio source scanning mechanism used in a Bluetooth audio playback apparatus, comprising:
establishing a one-to-one connection with a Bluetooth communication assistant apparatus;
performing an audio source scanning and generate audio source information according to a Bluetooth audio source apparatus that is found during the audio source scanning;
transmitting the audio source information to the Bluetooth communication assistant apparatus;
receiving a selection command from the Bluetooth communication assistant apparatus to select the Bluetooth audio source apparatus as a selected Bluetooth audio source apparatus; and
receiving audio data from the selected Bluetooth audio source apparatus and playbacking the audio data.

8. The Bluetooth communication method of claim 7, further comprising:
finding Bluetooth audio source apparatuses having a number of more than one during the audio source scanning, wherein the audio source information comprises information of the all the Bluetooth audio source apparatuses that are found during the audio source scanning, and the selection command selects one of the Bluetooth audio source apparatuses that are found during the audio source scanning as the selected Bluetooth audio source apparatus.

9. The Bluetooth communication method of claim 7, further comprising:
receiving a scan command from the Bluetooth communication assistant apparatus and performing the audio source scanning according to the scan command.

10. The Bluetooth communication method of claim 7, further comprising:
actively performing the audio source scanning.

11. The Bluetooth communication method of claim 7, further comprising:
establishing the one-to-one connection with the Bluetooth communication assistant apparatus by using Generic Attribute Profile protocol, Serial Port Profile protocol, Radio frequency communication protocol, Logical Link Control and Adaptation Protocol, Basic Rate/Enhanced Data Rate Asynchronous Connection-Oriented Logical Transport protocol or Low Energy ACL protocol.

12. The Bluetooth communication method of claim 7, further comprising:
receiving at least one of a periodic advertising packet and an extended advertising packet transmitted by the Bluetooth audio source apparatus to perform the audio source scanning.
